(19) United States
(12) Patent Application Publication
(10) Pub. No.: US 2006/0121185 A1
(43) Pub. Date: Jun. 8, 2006

(54) Carbon nanotube optical polarizer

(76) Inventors: Gann Xu, Boothwyn, PA (US); Ming Zheng, Hockessin, DE (US); Robert Scott McLean, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/005,353

(22) Filed: Dec. 6, 2004

(51) Int. Cl. C03C 17/00

(52) U.S. Cl. 427/163.1; 359/488

(57) ABSTRACT

Associated with a charged dispersant and preferably biopolymers, carbon nanotubes are aligned on a substrate by deposition onto the substrate directly from solution. Aligned carbon nanotubes polarize electromagnetic radiation and serve as an optical polarizer useful in a variety of applications.

### FIELD OF THE INVENTION

Carbon nanotubes (CNT) have been the subject of intense research since their discovery in 1991. Possessing unique properties such as small size, considerable stiffness, and electrical conductivity, carbon nanotubes, when aligned so as to refract or reflect light, are useful as optical polarizers in a wide range of applications, which include optical microscopes, sunglasses, and liquid crystal displays. Carbon nanotubes may be either multi-walled (MWNTs) or single-walled (SWNTs), and have diameters in the nanometer range.

### BACKGROUND OF THE INVENTION

Depending on their atomic structure, CNTs may have either metallic or semiconductor properties. These properties, in combination with their small dimensions make CNTs particularly attractive for use in the fabrication of nano-devices. A major obstacle to such efforts has been the difficulty in manipulating the nanotubes. Aggregation is particularly problematic because the highly polarized, smooth-sided fullerene tubes readily form parallel bundles or ropes with a large van der Waals binding energy. This bundling perturbs the electronic structure of the tubes, and it confounds all attempts to separate the tubes by size or type or to use them as individual macromolecular species. Various methods have been used to disperse carbon nanotubes. For example, commonly owned U.S. Patent Appl. Pub. No. 2004/0132072 and WO 2004/048256 teach that nucleic acid molecules are able to singly disperse high concentrations of bundled carbon nanotubes in an aqueous solution.

The usefulness of CNTs as an optical polarizer, especially in nano-optic devices and in displays, is increased if they could be physically aligned on a substrate, so that they can polarize light. Various methods have been used to align ropes of dispersed SWNT. Chen Q et al., (APPL. PHYS. LETT. 78: 3714 (2001)) used electrical fields while filtering dispersions of SWNTs to form thick films of aligned nanotubes. Rao, S G et al., (NATURE 425: 36 (2003)) used chemically functionalized patterns on a substrate to align sonicated SWNTs. Huang, Y et al., (SCIENCE 291: 630-633) formed aligned nanostructures by passing suspensions of nanowires through fluidic channels between a substrate and a mold. Smalley, R et al. (WO 01/30694) showed alignment of nanotube ropes in the presence of a 25 Tesla magnetic field.

See also, Wang, Y et al. (2004) Receiving and transmitting light-like radio waves: Antenna effect in arrays of aligned carbon nanotubes, APPL PHYS LETT 85(13):2607-2609, discussing their observations that aligned multi-walled nanotubes (MWNTs) when interacting with electromagnetic radiation, including light, operate like an array of dipole antennas. That is, each aligned MWNT polarizes incoming light like a channeling antenna. Wang et al. notes that the polarization effect has already been observed in SWNTs.

The problem to be solved, therefore, is to provide a method for the facile and inexpensive alignment of bundled carbon nanotubes for use as an optical polarizer in a range of uses and configurations, several of which are identified in U.S. Pat. No. 6,610,356 to Kausch et al., incorporated herein by reference. U.S. Pat. App. Pub. No. 2004/0047038 to Jiang et al. discloses a method for fabricating an optical polarizer using aligned carbon nanotubes, which merely pulls apart nanotube bundles to make a long, continuous nanotube “yarn” that is then cut and aligned more or less mechanically.

Jap. Pat. App. Pub. No. JP2002365427 to Kenji discloses a liquid crystal display polarizer, which comprises carbon nanotubes dispersed in a polymer and liquid crystal matrix. Alignment of carbon nanotubes was achieved either by stretching the film in a uniaxial direction or by co-aligning with a liquid crystal phase that is capable of self-arranging into one direction. Neither does this method singly disperse the nanotubes.

Applicants resolve the stated problem through the discovery that solutions of dispersed and solubilized carbon nanotubes will align during deposition on a substrate.

### SUMMARY OF INVENTION

The present invention provides a method of making an optical polarizer which comprises the steps of:
a) providing a population of carbon nanotubes associated with a charged dispersant in solution;
b) depositing the solution of (a) on a transparent substrate whereby the population of carbon nanotubes are aligned;
c) washing the transparent substrate of (b) with a washing solvent;
d) drying the washed transparent substrate of (c) whereby the aligned carbon nanotubes are affixed to the transparent substrate;
e) optionally coating the aligned carbon nanotubes with a transparent coating;
f) optionally repeating steps (a)-(d) or steps (a)-(e) to obtain multiple substrates;
g) incorporating the substrate of (d) or (e) or the multiple substrates of (f) into an apparatus.
   The carbon nanotubes may be single walled or multi-walled.

Another embodiment of the present method farther comprises the steps of:
h) combining at least two substrates obtained from step (d), (e) or (f) to form a multiple polarizer;
i) optionally combining a reflective substrate together with the multiple polarizer of step (h);
j) incorporating the multiple polarizer of step (h) or (i) into an apparatus.
   In this embodiment, the multiple polarizer may polarize a greater percentage of incident light with each combined substrate.

In one embodiment, the carbon nanotubes are substantially semiconducting or metallic. In another embodiment, the step of increasing the density of the carbon nanotubes may be added. The carbon nanotubes may be singly dispersed in a yet further embodiment. In other embodiments, the charged dispersant is a biopolymer selected from the group consisting of nucleic acids, polypeptides and peptide nucleic acids. In still other embodiments, the substrate may be selected from the group consisting of silicon, silicon dioxide, glass, polymers, crystals and combinations thereof. Moreover, in a different embodiment, the alignment may be performed in the presence of an external magnetic field. And, in a further embodiment, the washing solvent is aqueous based. In other embodiments, the transparent coating may be selected from the group consisting of adhesives, conductive layers, antistatic coatings or film, abrasion resistant materials and optical coatings.

In a different embodiment, the substrate may undergo a pretreatment. And in a further embodiment, the pretreatment makes the substrate more hydrophobic.

In any embodiment of the present invention, the present substrate may be incorporated into an apparatus selected from the group consisting of cameras, camera phones, displays, microscopes, optical scanners, optical spectrometers, polarized lenses, three-dimensional displays, three-dimensional viewers, three-dimensional microscopes, telescopes, displays, computer displays, television displays and personal digital assistants.

In addition, the present invention provides an optical polarizer made according to any of the present methods. The present invention also provides an apparatus that comprises the present optical polarizer. In further embodiments, the present apparatus may be selected from the group consisting of sunglasses, windshields, camera lenses, three-dimensional viewers, three-dimensional eyeglasses, spectroscopes, spectrophotometers, spectral analyzers, projection television displays and liquid crystal tunable filters.

The present invention also provides a microscope comprising the present optical polarizer made according to any of the present methods. In further embodiments, the present microscope may be selected from the group consisting of optical microscopes, fluorescence microscopes, interference microscopes, compound microscopes, polarized-light microscope, birefringence imaging microscopes and scanning near-field optical microscopes.

The present invention provides a display comprising the present optical polarizer. In other embodiments, the present display may be selected from the group consisting of a liquid crystal display, flat screen display and light emitting diode display.

### BRIEF DESCRIPTION OF THE FIGURES

FIG. 1 shows an AFM image of the alignment orientation of DNA wrapped CNT deposited on a SiO₂ surface at different spots (1400 μm×1400 μm area).

FIG. 2 shows an AFM image of the alignment orientation of DNA wrapped CNT deposited on a glass surface.

FIG. 3 shows the scheme for depositing DNA wrapped CNT under the influence of an external magnetic field.

FIG. 4 shows an AFM image of the alignment orientation of DNA wrapped CNT deposited on a SiO₂ surface at different spots (1400 μm×1400 μm area) under the influence of an external magnetic field.

FIG. 5 shows AFM and MFM images of CNT deposited on a SiO₂ surface at different spots (3 μm×3 μm area), before and after DNA removal.

FIG. 6 shows AFM images of CNT deposited on a pretreated SiO₂ surface at different spots.

FIG. 7 is a schematic diagram of light passing through crossed polarizers.

FIG. 8 is a view of the action of light polarization through polarized sunglasses.

FIG. 9 shows the operation of a three-dimensional viewer that polarizes different wavelengths of light for viewing stereoscopically.

FIG. 10 is a schematic diagram of a spectroscope showing the trajectory of unscattered visible light transmitted through a spectroscope, from gas specimen through polarizing lenses and through a prism, which scatters the individual color components into an emission spectrum characteristic of the gas.

FIG. 11 is a schematic diagram of the probe of a near field scanning optical microscope.

FIG. 12 is a schematic diagram of a simplified nematic liquid crystal display.

### DETAILED DESCRIPTION OF THE INVENTION

Abbreviations. The following abbreviations apply for the interpretation of the claims and the specification:

“CNT” refers to carbon nanotube.

“DNA” refers to deoxyribonucleic acid.

“LCD” refers to liquid crystal display.

“LED” refers to light emitting diode.

“MWNT” refers to multi-walled nanotube.

“PDA” refers to personal digital assistant.

“PNA” refers to peptide nucleic acid.

“PVA” refers to poly vinyl alcohol.

“RNA” refers to ribonucleic acid.

“SWNT” refers to single walled nanotube.

“3-D” refers to three-dimensional.

Definitions. The following definitions apply for the interpretation of the claims and the specification:

As used herein, “carbon nanotube” refers to a hollow article composed primarily of carbon atoms. The carbon nanotube can be doped with other elements, e.g., metals. The nanotubes typically have a narrow dimension (diameter) of about 1-200 nm and a long dimension (length), where the ratio of the long dimension to the narrow dimension, i.e., the aspect ratio, is at least 5. In general, the aspect ratio is between 10 and 100,000.

As used herein, “nucleic acid molecule” refers to a polymer of RNA, DNA, or peptide nucleic acid (PNA) that is single- or double-stranded, optionally containing synthetic, non-natural or altered nucleotide bases. A nucleic acid molecule in the form of a polymer of DNA may be comprised of one or more segments of cDNA, genomic DNA or synthetic DNA.

As used herein in a discussion of and referring to nucleic acids, the letters “A”, “G”, “T”, “C” refer to the purine bases adenine (C₅H₅N₅) and guanine (C₅H₅N₅O) and the pyrimidine bases thymine (C₅H₆N₂O₂) and cytosine (C₄H₅N₃O), respectively.

As used herein, “peptide nucleic acids” refers to a material having stretches of nucleic acid polymers linked together by peptide linkers.

As used herein, “charged dispersant” refers to an ionic compound that can function as a dispersant or surfactant. The charged dispersant can be anionic or cationic, and can be a single compound or polymeric.

As used herein in the context of a dispersant associated with a carbon nanotube, “associated with a charged dispersant” refers to the dispersant in physical contact with the nanotube, covalently or non-covalently. The nanotube surface should be substantially covered by the dispersant. The dispersant can be associated in a periodic manner with the nanotube. By “periodic” it is meant that the dispersant is associated with the nanotube at approximately regular intervals. Typical dispersants used with the invention are polymers and bio-polymers such as DNA, which are wrapped around the carbon nanotube and associated via hydrogen bonding effects.

As used herein, “nanotube-nucleic acid complex” refers to a composition comprising a carbon nanotube loosely associated with at least one nucleic acid molecule. Typically the association between the nucleic acid and the nanotube is by van der Waals bonds or some other non-covalent means.

As used herein in the context of the placement of carbon nanotubes on a substrate, “aligned” refers to the orientation of an individual nanotube or aggregate of nanotubes with respect to the others (i.e., aligned versus non-aligned). As used herein the term “aligned” may also refer to a 2 dimensional orientation of nanotubes laying relatively flat on a substrate.

As used herein, “affixed” generally refers to the state of being attached physically and/or of being secured to, say, the substrate of the present invention.

As used herein, “apparatus” generally refers to an instrument, device, appliance, equipment, or machinery designed to serve a specific function.

As used herein, “coating” generally refers to a film or thin layer applied to a substrate and/or over components lying on, over, attached to or embedded in a substrate. “Transparent coating” generally refers to a coating able to transmit light, especially in the visible wavelength range.

As used herein, “display” refers generally to an electronic apparatus that represents information in visual form and includes that made from plasma, liquid crystal and light emitting diode (LED) technology.

As used herein, “drying” generally refers to the removal of liquid by evaporation, and can be aided by heat, vacuum or chemical agents.

As used herein, “incorporating” generally refers to any process that results in a state by which the optical polarizer of the present invention becomes a part of, is formed into or united with an apparatus.

As used herein, “in solution” means a state in which the carbon nanotubes together with the charged dispersant form a homogeneous mixture from which the dissolved nanotubes can be recovered by physical processes.

As used herein, “multiple polarizer” comprises more than one polarizers made by the steps of the present method. Multiple polarizers may be aligned together or layered on top of each other, attached, laminated or otherwise combined with each other or oriented at various angles relative to each other.

As used herein, “optical polarizer” refers to a device that, when supplied with unpolarized light, produces light in which the electric field is constant or varies regularly, that is, light that is appreciably polarized. “Light” refers to electromagnetic radiation, and typically includes the visual wavelength range of about 400 to about 700 nm (nanometer), but may also include the shorter-wavelength, ultraviolet range, and the longer-wavelength, infrared range.

As used herein, “polarization” is a property of light such that the beam of light is aligned in waves traveling in a particular direction. The polarization of the beam is the fraction of the particles with the desired alignment. “Polarized light” refers to light whose vibration exhibits preference as to transverse direction or preference as to handedness or both. “Unpolarized light” refers to light that exhibits no long-term preference as to lateral direction of vibration or as to handedness.

As used herein, “reflective” refers to being capable of throwing back a transmitted light wave from a surface to produce an image. “Reflective substrate” can bounce back transmitted light from its surface either in a scattered pattern or in a specific direction, such as in the direction of the original propagated light source.

As used herein, “substrate” refers to any solid surface that is stable under process conditions. “Transparent substrate” is optically transmissive of light, and refers to a substrate able to transmit light, especially in the visual wavelength range.

As used herein, “washing solvent” generally means a substance that dissolves the excess component of a homogeneous mixture or that separates mixed substances by washing away those that are soluble in the solvent.

As used herein, “uniform length” as applied to a population of aligned carbon nanotubes means the tubes are of a relatively uniform dimension of length.

The above terms may be clarified and expanded, as well as all other terms are defined, by reference to the following dictionaries: the WEBSTER'S THIRD NEW INTERNATIONAL DICTIONARY, UNABRIDGED, Merriam-Webster, Springfield, Mass. (1993); Lewis, R J, HAWLEY'S CONDENSED CHEMICAL DICTIONARY, 14^{th} Ed, John Wiley & Sons, New York, N.Y. (2001); KIRK-OTHMER ENCYCLOPEDIA OF CHEMICAL TECHNOLOGY (ONLINE), ed. by John Wiley & Sons, New York, N.Y. (latest online edition) AND ULLMANN'S ENCYCLOPEDIA OF INDUSTRIAL CHEMISTRY (ONLINE), ed. by John Wiley & Sons, New York, N.Y. (latest online edition).

Method of Making Aligned Nanotubes

Carbon Nanotubes

Carbon nanotubes of the invention are generally about 0.5-2 nm in diameter where the ratio of the length dimension to the narrow dimension, i.e., the aspect ratio, is at least 5. In general, the aspect ratio is between 10 and 2000. Carbon nanotubes primarily comprise carbon atoms, however may be doped with other elements, e.g., metals. The carbon-based nanotubes of the invention can be either multi-walled nanotubes (MWNTs) or single-walled nanotubes (SWNTs). A MWNT, for example, includes several concentric nanotubes each having a different diameter. Thus, the smallest diameter tube is encapsulated by a larger diameter tube, which in turn, is encapsulated by another larger diameter nanotube. A SWNT, on the other hand, includes only one nanotube.

Carbon nanotubes (CNT) may be produced by a variety of methods, and additionally are commercially available. Methods of CNT synthesis include laser vaporization of graphite (Thess A et al., SCIENCE 273: 483 (1996)); arc discharge (Journet C et al., NATURE 388: 756 (1997)); and HiPCo (high pressure carbon monoxide) process (Nikolaev P. et al., CHEM. PHYS. LETT. 313: 91-97 (1999)). Chemical vapor deposition (CVD) can also be used in producing carbon nanotubes (Kong J et al., CHEM. PHYS. LETT. 292:567-574 (1998). Additionally CNTs may be grown via catalytic processes both in solution and on solid substrates (Li Y, et al., Chem. Mater. 13(3): 1008-1014 (2001); (Franklin, N et al., ADV. MATER. 12: 890 (2000); Cassell, A et al., J. AM. CHEM. SOC. 121: 7975-7976 (1999)).

Dispersants

Dispersants are well-known in the art and a general description can be found in “Disperse Systems and Dispersants”, Rudolf Heusch, ULLMANN'S ENCYCLOPEDIA OF INDUSTRIAL CHEMISTRY (ONLINE), ed. by John Wiley & Sons, New York, N.Y., DOI: 10.1002/14356007.a08_{—}577. The invention provides carbon nanotubes that are dispersed in solution, preferably singly dispersed. A number of dispersants may be used for this purpose wherein the dispersant is associated with the carbon nanotube by covalent or non-covalent means. The dispersant should preferably substantially cover the length of the nanotube, preferably at least half of the length of the nanotube, more preferably substantially all of the length. The dispersant can be associated in a periodic manner with the nanotube, such as wrapping. Preferred dispersants of the invention are charged polymers. In one embodiment synthetic polymers may be suitable as dispersants where they are of suitable charge and length to sufficiently disperse the nanotubes. Examples of polymers that could be suitable for the present invention include but are not limited to those described in O'Connell, M et al., CHEM. PHYS. LETT., 342: 265 (2001) and WO 2002/076888.

The solvent used for the nanotube dispersion can be any solvent that will dissolve the dispersant. The choice of solvent is not critical provided the solvent is not detrimental to the nanotubes or dispersant, and may be a mixture. Preferably the solution is water or aqueous based, optionally containing buffers, salts, and/or chelators.

In a preferred embodiment the dispersant will be a bio-polymer. Bio-polymers particularly suited for the invention include those described in WO 2004/048255, herein incorporated in its entirety by reference.

Bio-Polymers

Bio-polymers of the invention include those comprised of nucleic acids and polypeptides. Polypeptides may be suitable as dispersants in the present invention if they are of suitable charge and length to sufficiently disperse the nanotubes. Bio-polymers particularly well suited for singly dispersing carbon nanotubes are those comprising nucleic acid molecules. Nucleic acid molecules of the invention may be of any type and from any suitable source and include but are not limited to DNA, RNA and peptide nucleic acids. The nucleic acid molecules may be either single stranded or double stranded and may optionally be functionalized at any point with a variety of reactive groups, ligands or agents. The nucleic acid molecules of the invention may be generated by synthetic means or may be isolated from nature by protocols well known in the art (Sambrook, J et al., MOLECULAR CLONING: A LABORATORY MANUAL, Cold Spring Harbor Laboratory Press, Cold Spring Harbor, N.Y. (1989)).

It should be noted that functionalization of the nucleic acids is not necessary for their association with CNTs for the purpose of dispersion. Functionalization may be of interest after the CNTs have been dispersed and it is desired to bind other moieties to the nucleic acid or immobilize the carbon nanotube-nucleic acid complex to a surface through various functionalized elements of the nucleic acid. As used herein nucleic acids that are used for dispersion, typically lack functional groups and are referred to herein as “unfunctionalized”.

Peptide nucleic acids (PNA) are particularly useful in the present invention, as they possess the double functionality of both nucleic acids and peptides. Methods for the synthesis and use of PNAs are well known in the art. See, e.g., Antsypovitch, S I, Peptide nucleic acids: structure, RUSSIAN CHEMICAL REVIEWS 71(1): 71-83 (2002).

The nucleic acid molecules of the invention may have any composition of bases and may even consist of stretches of the same base (poly A or polyT for example) without impairing the ability of the nucleic acid molecule to disperse the bundled nanotube. Preferably the nucleic acid molecules will be less than about 2000 bases where less than 1000 bases is preferred and where from about 5 bases to about 1000 bases is most preferred. Generally the ability of nucleic acids to disperse carbon nanotubes appears to be independent of sequence or base composition, however there is some evidence to suggest that the less G-C and T-A base-pairing interactions in a sequence, the higher the dispersion efficiency, and that RNA and varieties thereof is particularly effective in dispersion and is thus preferred herein. Nucleic acid molecules suitable for use in the present invention include but are not limited to those having the general formula:
1. An wherein n=1-2000;
2. Tn wherein n=1-2000;
3. Cn wherein n=1-2000;
4. Gn wherein n=1-2000;
5. Rn wherein n=1-2000, and wherein R may be either A or G;
6. Yn wherein n=1-2000, and wherein Y may be either C or T;
7. Mn wherein n=1-2000, and wherein M may be either A or C;
8. Kn wherein n=1-2000, and wherein K may be either G or T;
9. Sn wherein n=1-2000, and wherein S may be either C or G;
10. Wn wherein n=1-2000, and wherein W may be either A or T;
11. Hn wherein n=1-2000, and wherein H may be either A or C or T;
12. Bn wherein n=1-2000, and wherein B may be either C or G or T;
13. Vn wherein n=1-2000, and wherein V may be either A or C or G;
14. Dn wherein n=1-2000, and wherein D may be either A or G or T; and
15. Nn wherein n=1-2000, and wherein N may be either A or C or T or G;

In addition to the combinations listed above, one of skill in the art will recognize that any of these sequences may have one or more deoxyribonucleotides replaced by ribonucleotides (i.e., RNA or RNA/DNA hybrid) or one or more sugar-phosphate linkages replaced by peptide bonds (i.e. PNA or PNA/RNA/DNA hybrid).

Once the nucleic acid molecule has been prepared it may be stabilized in a suitable solution. It is preferred if the nucleic acid molecules are in a relaxed secondary conformation and only loosely associated with each other to allow for the greatest contact by individual strands with the carbon nanotubes. Stabilized solutions of nucleic acids are common and well known in the art (see Sambrook supra) and typically include salts and buffers such as sodium and potassium salts, and TRIS (Tris(2-aminoethyl)amine), HEPES (N-(2-hydroxyethyl)piperazine-N′-(2-ethanesulfonic acid), and MES (2-(N-Morpholino)ethanesulfonic acid. Preferred solvents for stabilized nucleic acid solutions are those that are water miscible where water is most preferred.

Once the nucleic acid molecules are stabilized in a suitable solution they may be contacted with a population of bundled carbon nanotubes. It is preferred, although not necessary, if the contacting is done in the presence of an agitation means of some sort. Typically the agitation means employs sonication, for example; however may also include devices that produce high shear mixing of the nucleic acids and nanotubes (i.e. homogenization), or any combination thereof. Upon agitation the carbon nanotubes will become dispersed and will form nanotube-nucleic acid complexes comprising at least one nucleic acid molecule loosely associated with the carbon nanotube by hydrogen bonding or some non-covalent means.

The process of agitation and dispersion may be improved with the optional addition of nucleic acid denaturing substances to the solution. Common denaturants include but are not limited to formamide, urea and guanidine. A non-limiting list of suitable denaturants may be found in Sambrook et al., supra.

Additionally temperature during the contacting process will have an effect on the efficacy of the dispersion. Agitation at room temperature or higher was seen to give longer dispersion times whereas agitation at temperatures below room temperature (23° C.) were seen to give more rapid dispersion times where temperatures of about 4° C. are preferred.

Recovery of Dispersed Nanotubes

Once the nanotube-nucleic acid molecule complexes are formed they must be separated from solution as well as purified from any metallic particles, which may interfere in the dispersion by the charged dispersant. When the nucleic acid has been functionalized by the addition of a binding pair, for example, separation could be accomplished by means of immobilization through the binding pair as discussed below. However, where the nucleic acid has not been functionalized, an alternate means for separation must be found. Applicants have discovered that different applications, in this case gel electrophoresis chromatography or a phase separation method, can provide a rapid and facile method for the separation of nanotube-nucleic acid complexes into discreet fractions based on size or charge. These methods have been applied to the separation and recovery of coated nanoparticles (as described in U.S. patent application Ser. No. 10/622889 incorporated herein by reference) and have been found useful here. Another method of separating metallic from semi-conducting swnts in a suspension using alternating current dielectrophoresis is reported by Krupke, et al., (2003) Science 301: 344-347.

Alternatively the complexes may be separated by two-phase separation methods. In this method nanotube-nucleic acid complexes in solution are fractionated by adding a substantially water-miscible organic solvent in the presence of an electrolyte. The amount of the substantially water-miscible organic solvent added depends on the average particle size desired. The appropriate amount can be determined by routine experimentation. Typically, the substantially water-miscible organic solvent is added to give a concentration of about 5% to 10% by volume to precipitate out the largest particles. The complexes are collected by centrifugation or filtration. Centrifugation is typically done using a centrifuge, such as a Sorvall® RT7 PLUS centrifuge available from Kendro Laboratory Products (Newtown, Conn.), for about 1 min at about 4,000 rpm. For filtration, a porous membrane with a pore size small enough to collect the complex size of interest can be used. Optionally, sequential additions of the substantially water-miscible organic solvent are made to the complex solution to increase the solvent content of the solution and therefore, precipitate out complexes of smaller sizes.

After separation by any of the above methods it may be necessary to additionally filter the CNTs to remove any metallic particles, which may interfere with the dispersion or alignment of the CNTs.

Substrates

Solid substrates useful in the present invention are comprised of materials which include but are not limited to silicon, silicon dioxide, glass, metal, metal oxide, metal nitride, metal alloy, polymers, ceramics, and combinations thereof. Particularly suitable substrates will be comprised of for example, quartz glass, alumina, graphite, mica, mesoporous silica, silicon wafer, nanoporous alumina, silica, titania, ZnO₂, HfO₂, SnO₂, Ta₂O₃, TaN, SiN, Si₃N₄, and ceramic plates. Preferably, the substrate is quartz glass or silicon wafer.

In addition, suitable substrates for optical polarizers may be transparent solids, such as glasses, crystals and polymers, from which transparent, reflective or birefringent optical components may be made. Reflective polarizers typically comprise a component that creates a mirroring effect. Substrates may include but are not limited to lenses, optical flats and prisms. Substrate may influence the transmission of light passing through them resulting in refraction, dispersion and absorption, depending in part on the angle of light incidence and in part on properties of the materials themselves, such as their homogeneity, isotropy, etc, or, in sum, on the crystal axes of the materials. Altering the transmission of light passing through the substrate also occurs by varying the thickness of the substrate.

Optionally it may be useful to prepare the surface of the solid substrate so that it will better receive and bind the nano-structures. For example the solid substrate, especially metal oxide surfaces, may be pre-treated, micro-etched or may be coated with materials for better nano-structure adhesion and alignment. Methods for coating SiO₂ and other oxide surfaces are well documented in the literature; see, for example, Chemically Modified Oxide Surfaces, Vol. 3 (edited by D. E. Leyden, W. T. Collins, Publisher: Taylor & Francis, Inc., 1990).

One method of pre-treatment involves reacting the metal oxide surface to form covalent bonds between a desired functional group and the surface. A typical scheme for this type of chemical modification is to react a nucleophilic group with the hydroxyl groups on the oxide surface. One treatment is to make the surface more hydrophobic, such as but not limited to treating the surface with hydrocarbyl functional groups. A typical reaction is shown below, using SiO₂ to exemplify the metal oxide surface and R₃SiCl (where each R is one or more hydrocarbyl group) to exemplify the treatment reagent.

Any means known in the art can be used to affix the hydrocarbyl functional groups to the surface, preferably via covalent bonding between the functional groups and the surface.

By hydrocarbyl is meant a straight chain, branched or cyclic arrangement of carbon atoms connected by single, double, or triple carbon to carbon bonds and/or by ether linkages, and substituted accordingly with hydrogen atoms. Such hydrocarbyl groups may be aliphatic and/or aromatic. Examples of hydrocarbyl groups include methyl, ethyl, propyl, isopropyl, butyl, isobutyl, t-butyl, cyclopropyl, cyclobutyl, cyclopentyl, methylcyclopentyl, cyclohexyl, methylcyclohexyl, benzyl, phenyl, o-tolyl, m-tolyl, p-tolyl, xylyl, vinyl, allyl, butenyl, cyclohexenyl, cyclooctenyl, cyclooctadienyl, and butynyl. The hydrocarbyl group can be C1 to C30 in size.

Affixing CNTs to Substrates

In some situations it will be useful to immobilize or affix the CNTs to the surface of the substrate. This may be a first step in device fabrication or may be useful in CNT cutting methods.

Once a dispersed population of CNTs is prepared as described above, they may be dissolved in an aqueous solution and deposited on the solid surface or substrate where they become spontaneously aligned. Generally the deposited CNTs will remain on the substrate for a period of time of about 15 sec to about 60 min for good deposition. At this point it may be useful to wash the substrate with a washing solution or solvent. The washing solvent is used to remove the CNT solution after deposition of the nanotubes on the substrate. The solvent should be compatible and/or miscible with the solution containing the nanotubes. Preferably the solution is water or aqueous based, and should not leave any residue or impurities after removal.

After the surface is washed the CNTs will then be dried so as to affix them to the surface of the substrate. Drying can be accomplished by any means that does not damage the nanotubes. One preferred method is by passing a stream of gas over the substrate. Any gas may be used that is not reactive with the substrate or nanotubes.

After drying, the dispersant may be removed from the nanotubes by any chemical or physical means that will preferentially degrade the dispersant, such as but not limited to plasma, etching, enzymatic digestion, chemical oxidation, hydrolysis, and heating. One preferred method is by heating in the presence of oxygen.

After the tubes are aligned on the substrate, the nanotubes may be cut to a uniform length. Methods that can be used to cut the nanotubes include but are not limited to the utilization of ionized radiation including photon irradiation utilizing ionized radiation such as ultraviolet rays, X-rays, electron irradiation, ion-beam irradiation, plasma ionization, and neutral atoms machining, optionally through a photomask with a specific pattern. One such method is described in U.S. Pat. App. Pub. No. 2004/003855, incorporated herein by reference. Optionally the CNTs may be cut according to other means well known in the art (see for example: Zhang et al., Structure of single-wall carbon nanotubes purified and cut using polymer, APPL. PHYS. A 74: 7-10 (2002); Yudasaka et al., Effect of an organic polymer in purification and cutting of single-wall carbon nanotubes, APPL. PHYS. A 71: 449-451 (2000); Rubio et al., A mechanism for cutting carbon nanotubes with a scanning tunneling microscope, EUR. PHYS. J. B 17: 301-308 (2000); Stepanek et al., Cutting single wall carbon nanotubes, MAT. RES. SOC. SUMP. PROC. 593 (2000); and Park et al., Electrical cutting and nicking of carbon nanotubes using an atomic force microscope, APPL. PHYS. LETT. 80(23): (06 Oct. 2002).

In one embodiment it may be useful to begin with a population of CNT having a uniform length, and any of the above referenced methods for cutting CNTs may be used to process the CNTs prior to deposition to achieve that uniform length.

Optionally the methods of the present invention for aligning and affixing populations of carbon nanotubes on a substrate can be performed in the present of a weak external magnetic field, preferably less than about 0.5 Tesla (5000 Gauss), more preferably less than about 0.25 Tesla, even more preferably 0.1 Tesla. By “external magnetic field” it is meant an artificially produced magnetic field other than the earth's natural magnetic field. It should be noted here that the use of an external magnetic field is not essential but may, in some cases, enhance the rate of alignment of the nanotubes on the substrate.

Coatings

Also optionally it may be useful to apply a coating to the affixed nanotubes. Such a coating may be transparent or reflective depending on the application in which the present polarizer is used. Such coatings include but are not limited to: adhesion materials, conductive layers such as but not limited to indium tin oxide (ITO), antistatic coatings or film, abrasion resistant materials, optical coatings, and substances designed to improve the mechanical integrity or strength of the device. These coatings are well known in the art.

Carbon Nanotubes as Optical Polarizers

The present invention provides a method of aligning CNTs using the above described steps such that the aligned CNTs function as optical polarizers or, alternatively termed, polarizing filters. Carbon nanotubes have high mechanical strength, a high melting point and excellent resistant to humidity. Thus, the present polarizer made of dispersed CNTs and including film and flexible substrates is useful at high temperatures and in moist environments.

Carbon nanotubes possess the property of restricting particles from vibrating along their lengths. Thus, light waves traveling in a parallel orientation to aligned carbon nanotubes are absorbed, whereas light waves traveling in oblique or perpendicular orientations to the nanotubes are refracted or transmitted between the space of the aligned nanotubes. Dispersing the CNTs in a more compact fashion improves the polarizing ability of the substrate upon which they have been aligned. One way to achieve a more dense deposition of the aligned CNTs is by increasing deposition time to allow more CNTs to affix to a substrate. It is a reasonable expectation that increasing CNT density will correlate with the degree of polarization up to a certain point where dense CNT blocks light transmission.

Polarized light has applications in many technical fields, including crystallography, liquid-crystal displays, optical microscopy, three-dimensional (3D) viewers, polarizing sunglasses and the identification of optically active chemical compounds. The aligned nanotubes of the present invention may be useful optical polarizers in typical macro applications and are particularly adaptive in nano-optical devices. This is because the diameter of a carbon nanotube is about 0.4 to about 30 nanometers. Thus, the polarizing ability of the optical polarizer can extend into the ultraviolet (UV) region. See Umeda, N et al. Other Imaging and Applications, in NANO-OPTICS, ed. by Kawata, S. et al., Springer-Verlag, Berlin, 2002, pp:287-315 for a discussion of these devices, especially the near-field scanning optical microscope (NSOM).

Optical Polarization

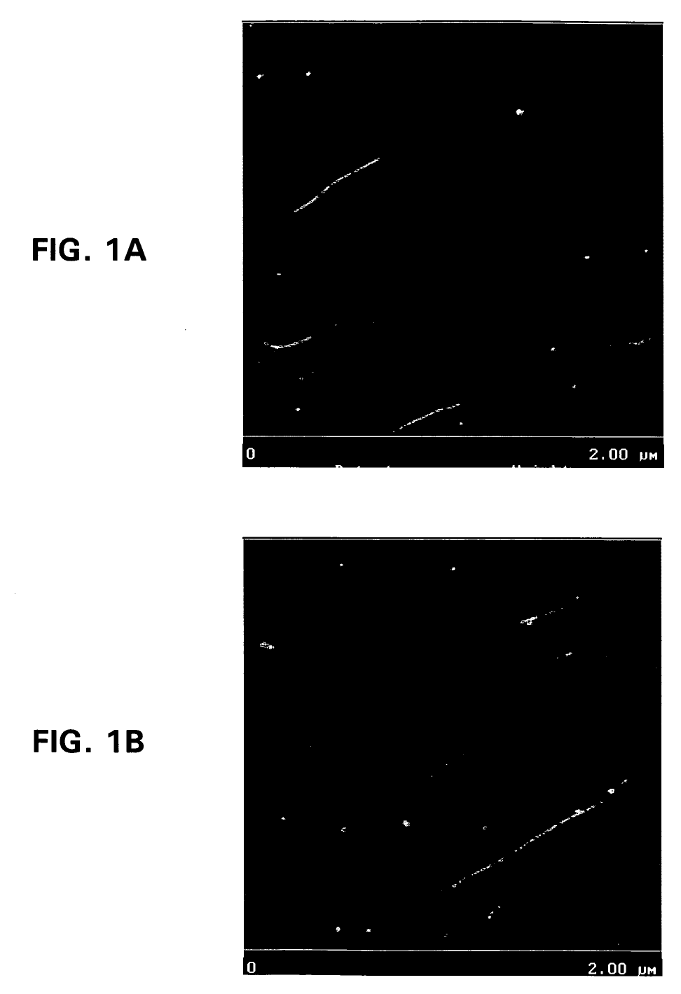

Unpolarized light consists of waves moving in the same direction with their electric vectors, or also termed waves, pointing in random orientations about the axis of propagation. Plane-polarized light consists only of electric vectors, or waves, that vibrate in one direction. See FIG. 1, which depicts polarized light passing through a first polarizer but blocked from passing through a second polarizer, whose plane of polarization is perpendicular to that of the first polarizer.

In general, polarization of light is accomplished either by refracting (or bending) light as it passes through a substrate or by reflecting it back off of a surface. Refraction occurs when a light wave passes through a boundary from one medium into another, which causes a change in the velocity of the light and can occur by transmission through polarizers. Especially in the context of optical microscopy, refracted light is discussed in terms of absorbed light because the filter or polarizer absorbs all unwanted waves of light and allows the wave of desired orientation to pass through. Reflection occurs when incident light bounces off the surface of a reflecting polarizer, e.g., a mirror or transparent material such as glass or water. For a thorough treatment of polarized light, see Shurcliff, W A, POLARIZED LIGHT: PRODUCTION AND USES, Harvard University Press, Cambridge, Mass. (1962), the entirety of which is incorporated herein by reference.

The more important refractive mechanisms for polarizing light include dichroism and birefringence (double refraction). The term dichroism refers to the selective absorption of certain components of an incident beam of light, which depends upon the vibration directions of the components. A dichroic polarizer preferentially transmits one polarization form of the light wave and absorbs the orthogonal form. Typical commercial dichroic polarizers have been made as sheet type polarizers comprising a transparent, hydrophilic polymeric material, such as poly vinyl alcohol (PVA), PVA after adsorbing iodine, polycarbonate, polypropylene, polyester, polymethyl methacrylate, polyether-sulfone, polyallylate or polyimide, or a film obtained by coating an isotropic or anisotropic base material with a refractive-index anisotropic material. See U.S. Pat. No. 6,795,246 to Yano et al., which is incorporated herein by reference.

A birefringent, or double refracting, polarizer typically has an anisotropic, i.e., non-isotropic or directionally dependent, crystalline lattice. Anisotropic crystals have crystallographically distinct axes, and interact with light in a manner that depends on the orientation of the crystalline lattice relative to the incident light. When light enters a non-equivalent axis, it is refracted into two rays, each polarized so that they travel at different velocities and so that their vibration directions are oriented at right angles to one another. A birefringent polarizer may be constructed of a multiple polarizer, that is, comprising two layered polarizers, which have been laminated or otherwise attached to each other and which transmit light waves through each layer at different velocities. Typically, it is the combination of layers that divides the incident beam into two rays to create, for example, two orthogonally polarized components, one of which is transmitted and the other, which may for example be totally internally reflected towards a blackened surface, as in a liquid crystal display. See, e.g., Yano, supra.

A reflective polarizer transmits polarized light such that the angle of the incident beam and the angle of the reflected beam are equal. The angles depend on the mirroring or matte surface qualities of the polarizer. Light may also be reflected when it is incident on a surface that is a boundary between two different materials. Reflecting polarizers generally include devices that transmit light of a first polarization and which reflect light of a second, different polarization.

In modern polarizers, some incident light waves of unpolarized light will have an orientation that is parallel to the axis of the polarizer, and these will be absorbed. Since some incident light waves will have an oblique orientation relative to the polarizing axis of the polarizer, these waves will only be partially absorbed. Those incident light waves having a perpendicular orientation relative to the polarizing axis of the polarizer will be transmitted. The most common type of polarizers are termed the H-series, which transmit only about 25 per cent of the incident light beam, but which polarize 99 percent of the transmitted rays.

Optical polarizing devices may include combinations of dichroic, birefringent and reflective polarizers, depending on the application. See, e.g., U.S. Pat. No. 6,575,044 to Sahouani et al.; U.S. Pat. No. 6,307,676 to Merrill et al. and U.S. Pat. No. 6,096,375 to Ouderkirk et al.

Generally, the aligned nanotubes of the present invention may function as dichroic, birefringent or reflective polarizers depending on the properties of the substrates onto which they are affixed, on the configuration in which they are used and on the alignment of the nanotubes relative to the wavelength of light passing through them.

Multiple Polarizers

The present invention may optionally comprise a multiple polarizer having two or more polarizers aligned or layered on top of each other, attached, laminated or otherwise combined with each other or oriented at various angles relative to each other. The polarization angles of each layer can be fixed relative to each other or can be adjustable. Using multiple polarizers may alter the polarizing function of the present invention. For example, a multiple polarizer may act as a birefringent polarizer or a reflective polarizer, depending on substrates and layering structure. Further, for example, several layers of polarizers may act as a single dichroic polarizer that increases the percentage of the transmitted light when the polarization fields of each layer are aligned. The functions of a layered polarizer depend on the alignment of the carbon nanotubes in each layer, on their density of deposition and on the orientation of light waves transmitting through each polarizer in the combination. An important application for using layered polarizers of the present invention is in liquid crystal displays.

Thicker Density

Also affecting the polarizing ability of the present invention may be the surface density of the nanotube deposition. As discussed in Example 8, an increase in the surface density of aligned nanotubes occurs the longer the DNA-CNT solution, for example, incubates with or is exposed to the substrate. The application of a weak external magnetic field at various times during aligning and affixing offers an opportunity to adjust the alignment on the substrate and therefore to govern the polarizing functionality of the present-polarizer.

Optical Polarizers of the Present Invention in Various Applications

The polarizer of the present invention can be used in a variety of applications, especially those employing dichroic, birefringent or reflective polarizers. See, especially, Kausch et al., supra. A distinct advantage to the present polarizer is in the manufacture of nano-devices designed for optical imaging and scanning, such as for birefringent imaging with a near-field scanning optical microscope (NSOM) as discussed in Umeda et al., supra and throughout NANO-OPTICS, ed. by Kawata, S et al., Springer-Verlag, Berlin 2002, incorporated herein in its entirety by reference.

Following is a brief description of some technological applications, which may employ the present polarizer. These include polarized sunglasses/windshield to reduce glare, optical microscopes and liquid crystal display devices. One of skill in the art would appreciate that the present invention is by no means limited to these applications and that other applications employing the present polarizer may include cameras, camera phones, displays, optical scanners, optical spectrometers, polarized lenses, three-dimensional displays, three-dimensional viewers, three-dimensional microscopes, computer displays, television displays and personal digital assistants. See, e.g. Ajayan, P M et al. Carbon nanotubes: From macromolecules to nanotechnology. PNAS 96:14199-14200 (1999), discussing that nanotube arrays can now be grown on glass substrates for field emitting flat panel displays; and Baughman, R H et al. Carbon Nanotubes—the Route Toward Applications, SCIENCE 297:787-792 (2002), illustrating a flat panel display based on carbon nanotubes, both of which are incorporated herein by reference.

Polarizing Sun Glasses, Windshields, Camera Lenses

Sunglasses may be manufactured using a substrate such as optical glass or plastic films to which the aligned CNTs of the present invention are applied. These glasses function as an optical polarizer because of the uniform alignment of the CNTs, which will preferentially absorb light oscillating in certain planes and transmit light in only one plane.

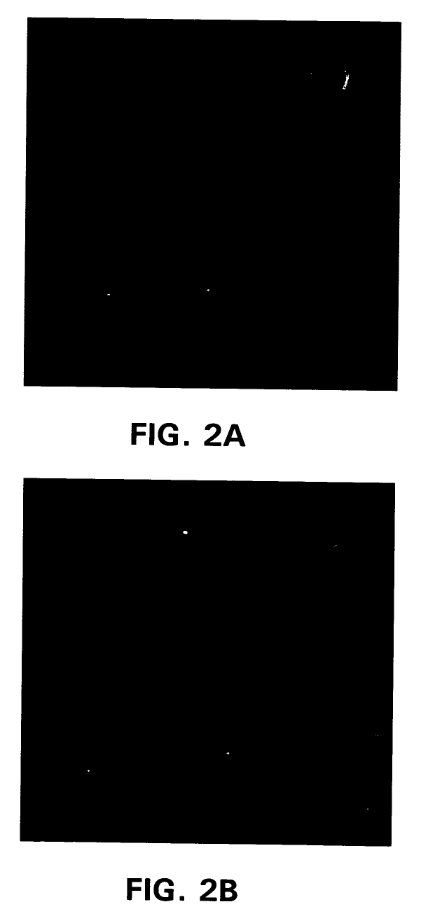

Some of the incident light reaching the eye is reflected from horizontal surfaces and vibrates in a direction parallel to the ground. Such a beam is responsible for the optical effect of glare, which reduces depth and clarity perception. As FIG. 2 shows, polarized sunglasses (or windshields or camera lenses) block parallel light beams from passing through the lenses, thereby reducing glare, while transmitting through those light beams vibrating perpendicularly to the reflecting surface, thereby admitting vision.

The present invention also may reduce glare, or enhance contrast, in photography when, for example, the aligned polarizers of the present invention—which may also comprise lenses—are mounted over a camera lens. This is done typically by means of a mounting ring that allows the filters/lenses to rotate to achieve the desired effect under different lighting conditions. Moreover, the present invention may reduce headlight glare when, for example, DNA-CNTs are deposited to the windshields of vehicles. Thus, the present invention may be applied to sunglasses, camera lenses and windshields. Those of skill in the art of making sun glasses, camera lenses, windshields and other glare-blocking surfaces can readily adapt the optical polarizers of the present invention to transmit, reflect and/or block light at the known and preferred angles of refraction and reflection to achieve the desired function.

Three-Dimensional Viewers

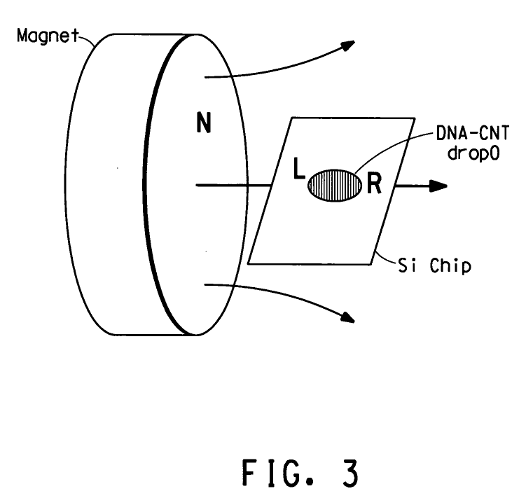

Owing to the distance between the eyes, each eye sees a slightly different image; this is termed binocular vision. As FIG. 3 shows, three-dimensional (3-D) viewing relies on the use of two cameras to photograph the same image from slightly different positions to create slightly different images. Projecting these slightly different images using synchronized projectors simulates the information the brain receives through binocular vision. Therefore, using a 3-D viewer, fitted with a different polarizing lens for each eye, it is possible to perceive three-dimensionality in the projected images. This is because a 3-D viewer, such as 3-D glasses, transmits images of differently polarized light into each eye.

The present invention may be used to create polarizing filters or lenses useful in a variety of 3-D viewing applications, which include, but are not limited to, 3-D glasses having differently polarized lenses for color viewing; 3-D screens, such as TV screen displays that rapidly alternate one right eye image and left eye image other; and special liquid crystal display glasses that block the view of one eye and then the other in rapid succession.

Spectroscopy (Spectrolphotometry)

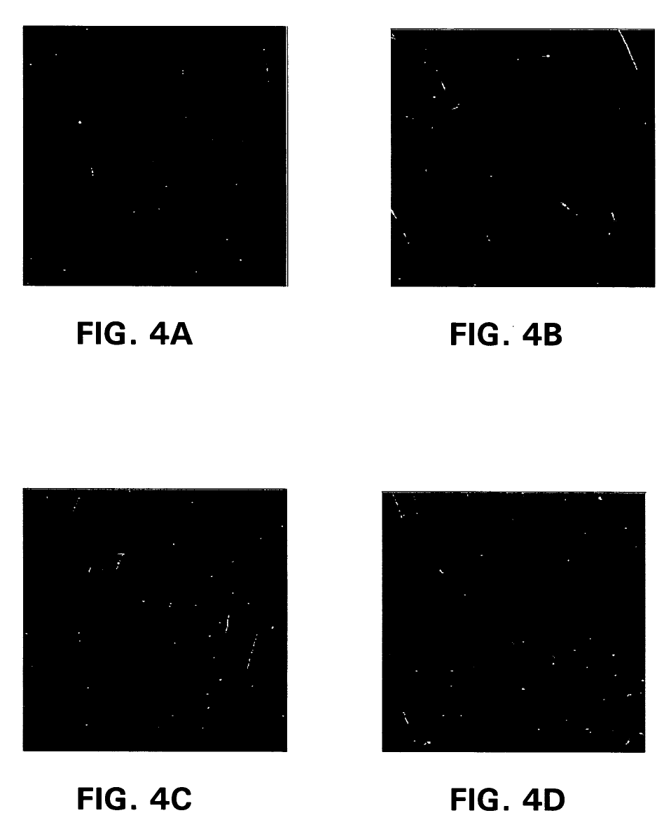

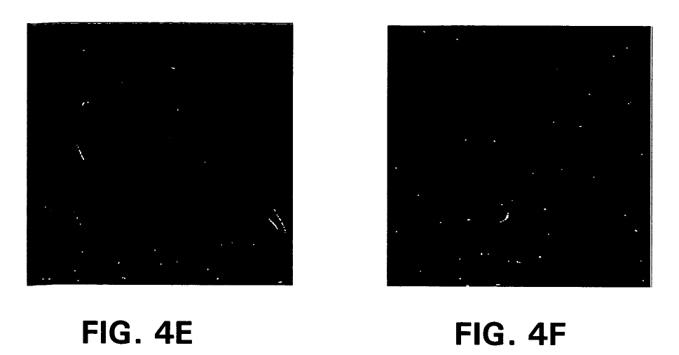

The present invention may be used as one or more aligned polarizers or lenses to produce channeled spectra in a spectrophotometer or a spectroscope, especially for ultraviolet (UV)-visible (VIS) light spectra. See FIG. 4, which presents a schematic of a spectroscope (or spectrophotometer). By measuring the amount of electromagnetic radiation a color sample reflects or transmits at each wavelength, a spectroscope measures and thereby produces spectral data. Spectral data can be analyzed qualitatively and quantitatively to investigate atomic and molecular structure. A well-known use of spectral data is to monitor and measure atmospheric pollutants.

UV-VIS absorption results from transitions between outer electron shells, caused by a specific moiety or structure in a molecule termed the chromophore. Different chromophores exhibit absorptions at specific wavelengths and have characteristic intensities, which are tabulated in handbooks, and can be used as fingerprints to identify various chemicals. Scanning UV-VIS diode-array absorption detectors are used in high performance liquid chromatography (HPLC).

The technology and theory behind the function and making of a spectroscope is well known and reviewed by McDowell, S et al. Optical Spectroscopy in Kirk-Othmer Encyclopedia of Chemical Technology, ed. by John Wiley & Sons, Inc. DOI: 10.1002/0471238961.1916050313030415.a01 (2000), incorporated herein by reference. Absorption, emission, scattering, and fluorescence and phosphorescence, speciroscopies are mature applications in which those skilled in the art may readily employ the present polarizer. Similar to a spectroscope, a spectrophotometer is a spectrum analyzer and can divide a light wave signal into its constituent wavelengths and may similarly employ the present invention as lenses as shown in FIG. 4.

Optical Microscopes

The present invention is especially useful in optical microscopy for polarizing and absorbing light emitted by or transmitted to or through a specimen or sample. The present invention could readily be used as an absorption filter in an optical microscope. Absorption filters are commonly manufactured from dyed glass or pigmented gelatin resins and are one of the most widely used types of filter for brightfield and fluorescence microscopy. Absorption filters operate by attenuation of light through absorption of specific wavelengths, so that spectral performance is a function of the physical thickness of the filter and the amount of dye present in the glass or gelatin matrix. Absorption filters represent the largest class and most widely used type of filters for optical microscope applications that do not require a precise definition of transmitted wavelengths. Commonly used to isolate a broad band of wavelengths, absorption filters are also helpful to block short wavelengths while transmitting longer ones. The quality of glass or polymer used in the manufacture of filters is important, and should be of optical grade and provide uniformity of density and color over the entire surface of the filter. Filter glass or plastic attenuates light only through absorption, so the spectral performance is dependent upon the thickness and optical density of the filter material. Increasing the thickness will produce a corresponding increase in the blocking level of unwanted wavelengths, but also reduces the peak in-band transmission, causing falloff at the ends of absorption bands.

The present invention can serve not only in a basic brightfield configuration as a polarizer but also in the condenser, which may for example optimize the light intensity and angle coming from the light source so that the specimen is illuminated with uniform intensity. The present invention is useful in interference-creating microscopes, such as the phase contrast and especially its complement, the differential interference contrast (DIC), which uses polarizing filters and prisms to separate and recombine the light paths, giving a 3-D appearance to the specimen. The present invention is well suited for use in the polarized-light microscope, which uses two polarizers on either side of the specimen, positioned perpendicularly to each other so that only light that passes through the specimen reaches the eyepiece.

In addition, the present invention may be useful in fluorescence microscopy. Fluorescence is the property of some atoms and molecules to absorb light at a particular wavelength and to subsequently emit light of longer wavelength after a brief interval, termed the fluorescence lifetime. A fluorescence microscope is essentially the same as conventional bright field microscopy, except that the light source emits low wavelength UV light and strikes a dichroic polarizer, actually a mirror that reflects one range of wavelengths and allows another to pass through. The transmitted light is polarized by filters above and below the fluorescently stained sample, which allow the microscopist to select the exciting wavelength and the wavelength of the collected light. The present invention could provide the dichroic polarizer and the various filters.

Similar to its use in fluorescence microscopy, the present polarizer may be used in confocal microscopy, for example in a reflective light confocal microscope or in a laser scanning confocal microscope (LSCM), which is typically employed for viewing fluorescently stained living cells and tissues. An LSCM beams a rastered monochromatic laser over the area of interest and records via a detector the light intensity at each position. As the beam is scanned over the sample, successive points are plotted to form the complete image. The LSCM uses dichroic mirrors and interference filters, such as high, low and band pass, to select the desired wavelengths to excite the area of interest. A CNT polarizer of this invention may integrate into an LSCM to provide better light selection.

The present invention may also be used as polarizers in a compound microscope configuration. Typically this comprises an optical microscope coupled to an array of CCDs, which serve as the imaging sensor, and is controlled by software that enhances contrast, focus, brightness and resolution and is generally used for 3-D imaging and for producing a stack of time-lapsed images. To boost magnification, the microscope has a complex objective lens system with a combination of two lenses of different materials, which corrects chromatic aberration. Compound microscopes are often fluorescence or confocal microscopes using laser and conventional illumination sources. The CCDs convert light into electrons, thereby generating a digitalized image on a display screen or storing it on digital media. In addition, a particularly useful compound microscope is a polarized light microscope, which uses birefringence to image transparent or translucent materials, such as many structures in the cell, certain plastics and polymer fibers. As discussed above, birefringent microscopes generally rely on crossed polarizers.

The present invention may be useful in a near-field scanning optical microscope (NSOM), an imaging configuration that combines a scanning probe microscope (SPM) and a light microscope. In an NSOM configuration, the present polarizer could typically be incorporated into the light microscope. Having nano-meter resolution and capable of imaging single atoms, an SPM possesses a very sharp probe, positioned about 1 nanometer above a surface, which scans just above the surface. SPMs function by the principle of field emission, whereby electrons are pulled from the surface by a sufficiently high electrostatic field. That is, electrons “tunnel” between the tip of the probe and the specimen. Most SPMs use the light microscope for precise alignment of the detection system and positioning of the SPM tip. SPMs include the scanning tunneling microscope (STM), which images only electroconductive materials, and the atomic force microscope (AFM), which images insulating and conductive material. In an NSOM, the size of the probe, the structure of the specimen and the distance between the specimen and probe are all smaller than the illuminating wavelength. Consequently, the resolution of an NSOM image depends largely on the size of the illuminating beam and on its polarization in order to travel through the aperture.

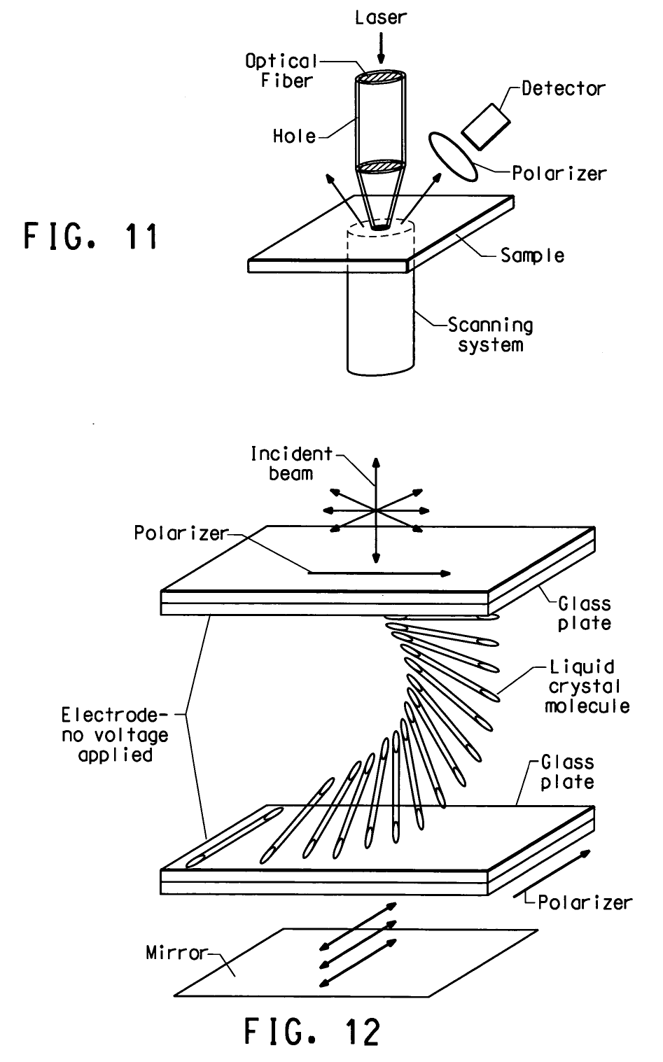

FIG. 11 shows a traditional NSOM in which the light of a laser is coupled into a single mode optical fiber, which is coated with metal. A scanning system moves the sample relative to the fiber while a feedback system maintains the distance of the fiber tip to the surface in the desired optical “near field” range. A detector receives reflected or transmitted light over a collection system. Detectors may be for example spectrometer, or more simply a photomultiplier.

Traditional light microscopy is an especially mature technical field. Other areas of resolution and imaging, especially interference, compound, and scanning microscopy, have developed in the last half-century at a rate that also qualifies these as mature. For that reason, skilled persons in the art will appreciate the variety of uses of the polarizer of the present invention and acknowledge that the above discussion does not limit, but only illustrates, the employment of the present polarizer in optical microscopy.

Liquid Crystal Applications

Liquid crystals are molecules that under some conditions exist in a phase in which they exhibit isotropic, fluid-like behavior. Such crystals are widely employed in liquid crystal displays (LCDs) because they align with an electric field, altering the polarization of light. FIG. 12 shows a schematic diagram of a simplified liquid crystal display, having a front and a back glass substrate, each with a polymeric coating on one side, which acts to polarize incident light. The glass substrates form a “sandwich” such that the polymeric coating faces out and the polarizing coatings orient incident light beams perpendicular to each other in the center of the sandwich. Each inside face of the glass substrates has microscopic grooves etched on, which lie in the same direction as the respective polarizing film on the outside face. Each inside face receives a coating of typically nematic liquid crystals. As light passes through the liquid crystal layers in the middle of the sandwich, the liquid crystals attempt to align with the perpendicular light beams created by the polymeric coatings on either side of the sandwich. This results in layers of molecules that appear to twist or spiral from one glass substrate to the other. Other kinds of liquid crystals include smectic or cholesteric liquid crystals, each of which creates its distinct kind of alignment patterns between the glass substrates.

LCDs are characterized according to their modes and to the number of electrical contacts per pixel. Because they do not emit their own light, LCD modes include transmissive, also known as backlit, or reflective. In a transmissive LCD, the pixels are illuminated from one side of the glass substrate sandwich and viewed from the opposite side, which offers high contrast and deep colors. Reflective LCDs bounce back polarized light from the environment in which they are functioning to the viewer, which make these displays better suited for bright and medium light conditions. Transflective LCDs use a combination of transmissive and reflective modes. Active LCDs generally have an electrical contact per pixel, whereas passive LCDs generally have one set of contacts for each row and column of pixels.

Smaller LCD devices such as watches and calculators typically possess reflective modes and passive-type displays. High-brightness applications, such as a computer monitor, typically possess a transmissive mode and are passive-type displays. Medium-sized devices such as personal digital assistants have a reflective mode and are active-type displays.

In contrast to nematic twisted LCDs, in which the crystals and electrodes are sandwiched between polarized glass plates, liquid crystal on silicon (LCOS) devices have the crystals coated over the surface of a silicon chip. The electronic circuits that drive the formation of the image are etched into the chip, which is coated with a reflective (aluminized) surface. The polarizers are located in the light path both before and after the light bounces off the chip. A typical LCOS device is a projection television display.

The present polarizer may be useful in LCDs as a dichroic, birefringent, reflective, interference or a combination of these. Fabricating LCD polarizers and display devices containing these is a mature field and provides skilled artisans abundant guidance for incorporating the present polarizer into a display device. Specific examples include: U.S. Pat. No. 6,795,246 to Yano et al., disclosing a birefringent polarizing film as the sandwiching substrates between the liquid crystal cell; U.S. Pat. No. 6,767,594 to Miroshin et al., disclosing an interference polarizer that increases refraction as the wavelength increases; U.S. Pat. No. 6,515,785 to Cobb, Jr. et al., U.S. Pat. No. 5,963,372 to Barak, and U.S. Pat. No. 6,348,995, disclosing reflective polarizers in LCDs.; see also U.S. Pat. App. No. 2004/018984 to Kim; U.S. Pat. App. No. 2004/0174478 to Fukuda et al. It is notable that the present polarizer could be adapted for use in these examples.

Besides LCDs, the present invention may be useful in liquid crystal tunable filters (LCTF). LCTFs use electrically controlled liquid crystal molecules to select a specific visible wavelength of light for transmission through the filter at the exclusion of all other wavelengths. The preferred use for an LCTF is with electronic imaging devices such as charge-coupled devices (CCDs), because it gives premier quality imaging with a simple linear optical pathway. A typical LCTF is constructed from a stack of fixed filters consisting of interwoven birefringent crystal/liquid-crystal combinations and linear polarizers. Typically, an LCTF can be a Lyot filter, in which three layers of liquid crystals sandwiched between birefringent crystals separate 4 several polarizers.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

### General Methods

Nucleic acids used in the following examples was obtained using standard recombinant DNA and molecular cloning techniques as described by Sambrook, supra, by T. J. Silhavy, M. L. Bennan, and L. W. Enquist, Experiments with Gene Fusions, Cold Spring Harbor Laboratory, Cold Spring Harbor, N.Y., 1984, and by Ausubel, F. M. et al., Current Protocols in Molecular Biology, Greene Publishing Assoc. and Wiley-Interscience, N.Y., 1987.

The meaning of abbreviations used is as follows: “min” means minute(s), “h” means hour(s), “μL” means microliter(s), “mL” means milliliter(s), “L” means liter(s), “nm” means nanometer(s), “mm” means millimeter(s), “cm” means centimeter(s), “μm” means micrometer(s), “mM” means millimolar, “M” means molar, “mmol” means millimole(s), “μmole” means micromole(s), “g” means gram(s), “μg” means microgram(s), “mg” means milligram(s), “g” means the gravitation constant, “rpm” means revolutions per minute.

### Example 1

### Purification of Carbon Nanotubes by Size-Exclusion Chromatography

This Example describes preparation of carbon nanotube materials used for experiments in the subsequent Examples. Unpurified single wall carbon nanotubes from Southwest Nanotechnologies (SWeNT, Norman, Okla.) and single-stranded DNA of either (GT)30 or random sequence were used as dispersion agents.

Dispersion was done as described in U.S. 60/432804 herein incorporated by reference. A size exclusion column Superdex™ 200 (16/60, prep grade) from Amersham Biosciences (Piscataway, N.J.)) was chosen for the HPLC purification. A volume of 2 mL of DNA-dispersed carbon nanotubes at a concentration of ˜100 μg/mL was injected into the column mounted on a BioCAD/SPRINT HPLC system (Applied Biosystems, Foster City, Calif.), and eluted by 120 mL of a pH 7 buffer solution containing 40 mM Tris/0.2M NaCl, at a flow rate of 1 mL/min. Fractions were collected in 1 mL aliquots. DNA-CNT hybrids eluted from the column after about 40 mL of elution volume. The earlier fractions contained longer and more pure DNA-CNT hybrids than later fractions, as shown by atomic force microscopy (AFM).

Purified DNA-CNTs were then exchanged into pure H₂O using Microcon® centrifugal filter YM-100 (Millipore, Bedford, Mass.) and diluted to a final concentration of about 2 μg/mL. This step served to remove any metallic particles or other impurities that could interfere with device fabrication or function.

### Example 2

### Deposition of DNA-CNT Solution on to SiO₂ Surface

Silicon chips (about 1 cm×2 cm) with different thickness (100 to 500 nm) of thermal oxide layer on substrates of different crystal orientation and doping were used for this experiment.

Typically the center of a 1 cm×2 cm chip, a 2.5 mm×2.5 mm square was marked to define the location for solution deposition of the CNTs. Immediately before deposition, the SiO₂ surface was scrubbed with Kimwipes® EX-L tissue (Kimberly-Clark, Roswell, Ga.) wetted with methanol. A 5 μL of DNA-CNT solution (2 μg/mL in water) was mixed with an equal volume of 20 mM Tris/0.5 mM EDTA pH7 buffer, and then the entire 10 mL mixture was deposited onto the area defined by a marked square. After a 15 min incubation at room temperature, the surface was rinsed with pure water and blown dried with N₂ gas.

### Example 3

### CNT Alignment Observation by Atomic Force-Microscopy

After deposition the alignment of the CNTs was observed using atomic force microscopy (AFM).

Tapping mode AFM was used to obtain height and phase imaging data simultaneously on a Nanoscope IIIa AFM, Dimension 3000 from Digital Instruments, (Santa Barbara, Calif.). Microfabricated cantilevers or silicon probes (Nanoprobes®, Digital Instruments) with 125 micron long cantilevers were used at their fundamental resonance frequencies, which typically varied from 270-350 kHz depending on the cantilever. The cantilevers had a very small tip radius of 5-10 nm. The AFM was operated in ambient conditions with a double vibration isolation system. Extender electronics were used to obtain height and phase information simultaneously. AFM data were obtained in tapping mode, in air, using previously described methods. FIG. 1 shows the alignment orientation at two different spots on the chip for CNTs deposited as described in Example 2. As can been seen in the figure, the CNTs are well aligned in both places on the substrate.

### Example 4

### Alignment Independence of DNA Sequence and CNT Length

This Example demonstrates that the alignment of CNTs observed in Example 3 was independent of DNA sequence and CNT length.

A 60 bp long random ssDNA sequence was used to disperse and purify CNT following the procedure described in Example 1. The DNA-CNT solution was then deposited on a SiO₂/Si surface following the procedure described in Example 2. AFM measurement revealed similar CNT alignment as shown in Example 3. Similarly, CNTs of different lengths obtained by the size-exclusion fractionation described in Example 1 were tested for alignment. In all cases, CNT alignment was observed by AFM (data not shown). The alignment was shown to be independent of DNA sequence or CNT length.

### Example 5

### DNA-CNT Alignment on Non Silicon Substrates

This Example illustrates that CNT alignment can also be observed on surfaces other than SiO₂/Si surface.

CNTs were prepared as described in Examples 1 and 2 and deposited on Coming barium borosilicate 7059 glass in the place of SiO2. Alignment was observed using AFM as described in Example 3. FIG. 2 shows DNA-CNT alignment on Coming 7059 glass. Referring to FIG. 2, two images (3 μm×3 μm ) are taken from two different spots on the glass substrate As can be seen, in each image the nanotubes are aligned along a particular direction, indicating alignment on a non-silicon substrate according to the method of the invention.

### Example 6

### Dependence of CNT Alignment on Magnetic Field

This example illustrates that the alignment phenomenon seen by the solution deposition of CNTs on a surface is independent of external magnetic fields.

To test magnetic field effect, the deposition protocol described in Example 2 was carried out in a magnetic field under a configuration as shown in FIG. 3. The experiment was carried out in the presence of a magnetic separation rack (New England BioLabs (Beverly, Mass.)). The magnet was a Neodymium rare earth permanent magnet, which generated a gradient field as illustrated by the arrows in FIG. 3. The field strength at the left (L) and right (R) edge of the drop was about 2500 Gauss and about 1500 Gauss (0.25 to 0.15 Tesla), respectively, as measured by a Gauss meter. Alignment of DNA-CNT was observed either with or without magnetic field and the results are shown in FIG. 4. Referring to FIG. 4, a total of six 6 □m×6 □m images are shown, taken within an area of 1400 m×1400 μm on the substrate. As can be seen, within each image, nanotubes are well aligned along one particular direction. Moving form left to right beginning with the top left image, a slight variation of the alignment orientation is observed. The overall variation is estimated to be ≦20°, suggesting that magnetic field exerts an alignment force onto the DNA-CNT. This interaction is further supported by Example 7.

### Example 7

### Magnetic Force Microscopy of DNA-CNT

In addition to normal Tapping Mode AFM, when using a magnetic AFM tip one can map magnetic forces associated with the DNA-CNT that are dispersed on the substrate. Magnetic Force Microscopy (MFM) is a secondary imaging mode derived from Tapping Mode. This is performed through a two-pass technique, where the probe is lifted off the surface to be scanned (Lift Mode). Lift Mode separately measures topography and magnetic force using the topographical information to track the probe tip at a constant height (Lift Height) above the sample surface during the second pass. The MFM probe tip is coated with a ferromagnetic thin film. While scanning, it is the magnetic field's dependence on tip-sample separation that induces changes in the cantilever's resonance frequency or phase. MFM can be used to image both naturally occurring and deliberately written domain structures in magnetic materials.

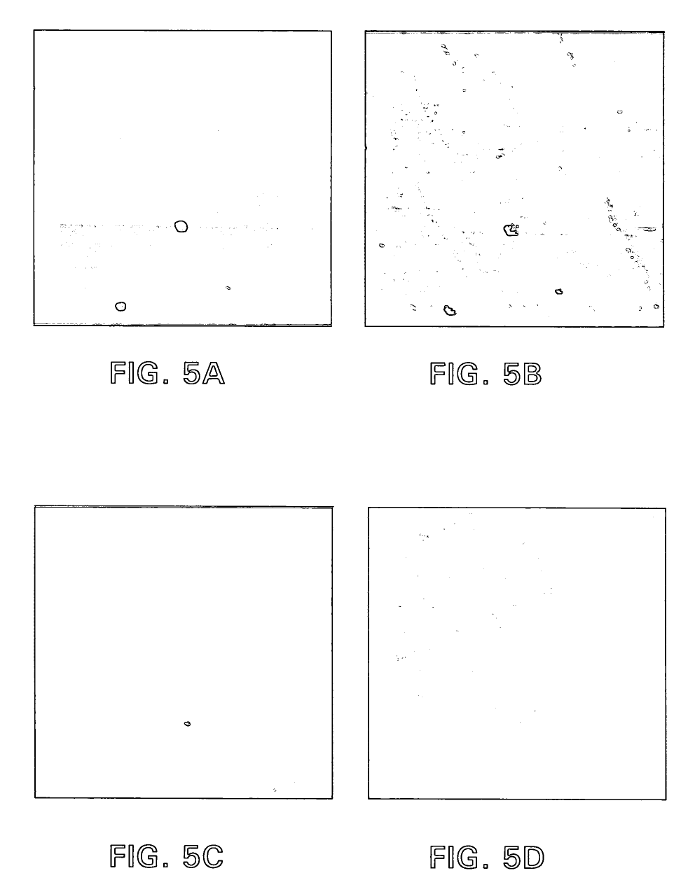

In this example MFM was used to image magnetic forces for DNA-CNT dispersed on SiO₂. FIG. 5 shows deposited DNA-CNT as prepared in Example 2 under the influence of a well-defined magnetic signal. FIGS. 5a and 5b show the AFM and MFM images, respectively, of the DNA-CNT sample, where the CNTs are associated with the polymer dispersant. As the MFM image reproduces the topography profile given by the AFM image, this result indicates that DNA-CNT hybrids possess magnetic moment.

In order to determine if the origin of the magnetic moment the deposited CNTs were due to the presence of the polymer dispersant, the substrates were heated to 350° C. for 2 hours to remove any DNA form the CNT. FIGS. 5c and 5d show the AFM and MFM images, respectively after DNA removal. It was clear that after DNA removal the magnetic signal was greatly reduced, suggesting that the magnetic forces are not primarily attributable to the CNTs themselves. This result indicates that DNA-CNT complex does possess a magnetic moment.

### Example 8

### Controlled Hydrophobic Layer Formation for Global Alignment

This Example describes a method for making a hydrophobic layer on the SiO₂ surface and the resulted improvement in DNA-CNT alignment. A commercially available silylation agent Sigmacote® (Sigma-Aldrich) was used. In a typical experiment, 50 μL of Sigmacote® was deposited onto the clean SiO₂ surface of a 1 cm×2 cm chip. The volume of the agent should be enough to cover the entire surface. After 30 sec. incubation, the treated chip was rinsed with pure water. Since the treated surface became hydrophobic, rinsing did not leave any water on the surface. Carbon nanotube deposition was then done the same way as described in Example 2. A 5 μL of DNA-CNT solution (2 μg/mL in water) was mixed with an equal volume of 20 mM Tris/0.5 mM EDTA pH7 buffer, and then the entire 10 mL mixture was deposited onto the treated surface. After a 15 min incubation at room temperature, the surface was rinsed with pure water and blown dried with N₂ gas.

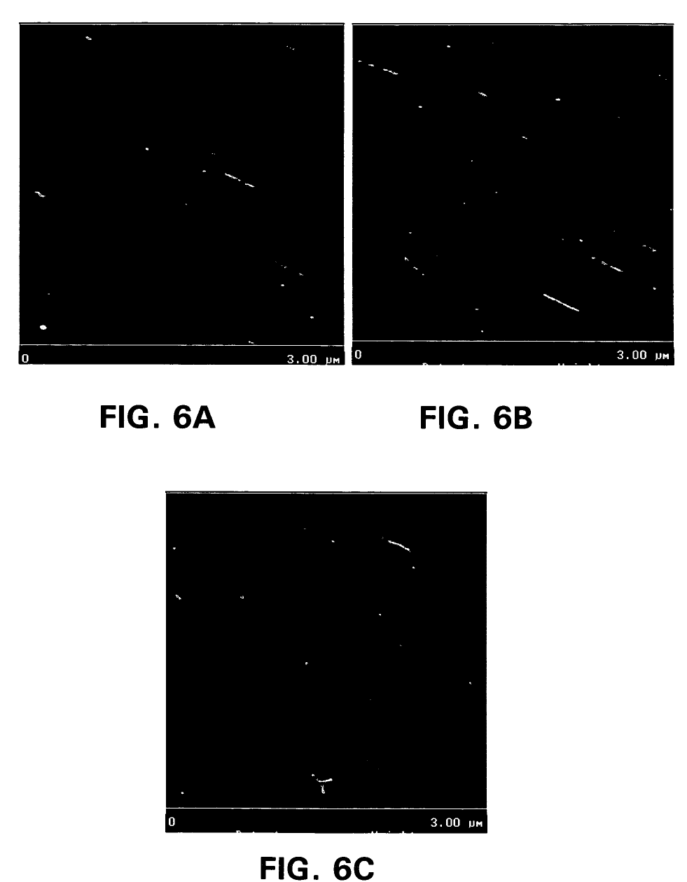

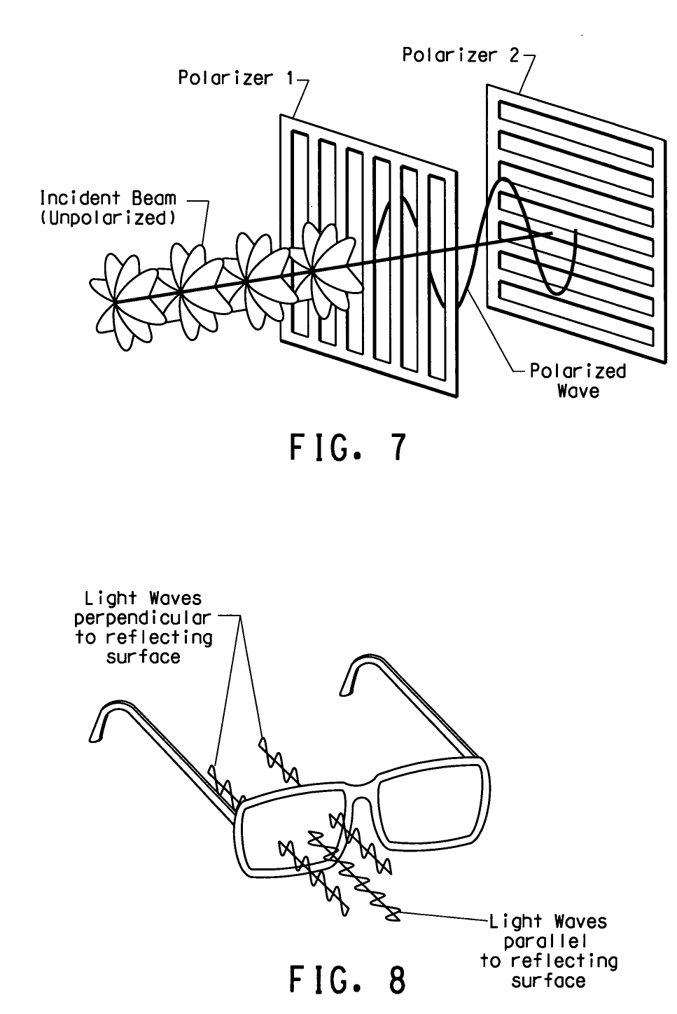

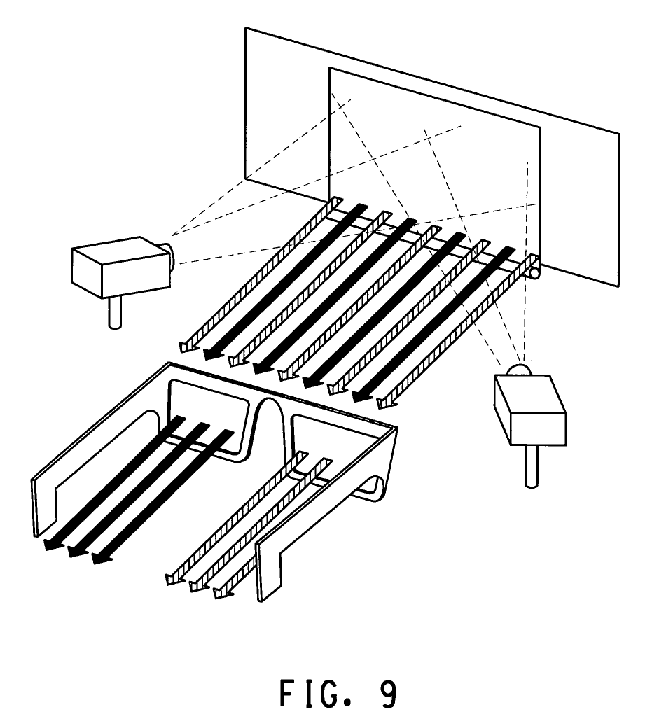

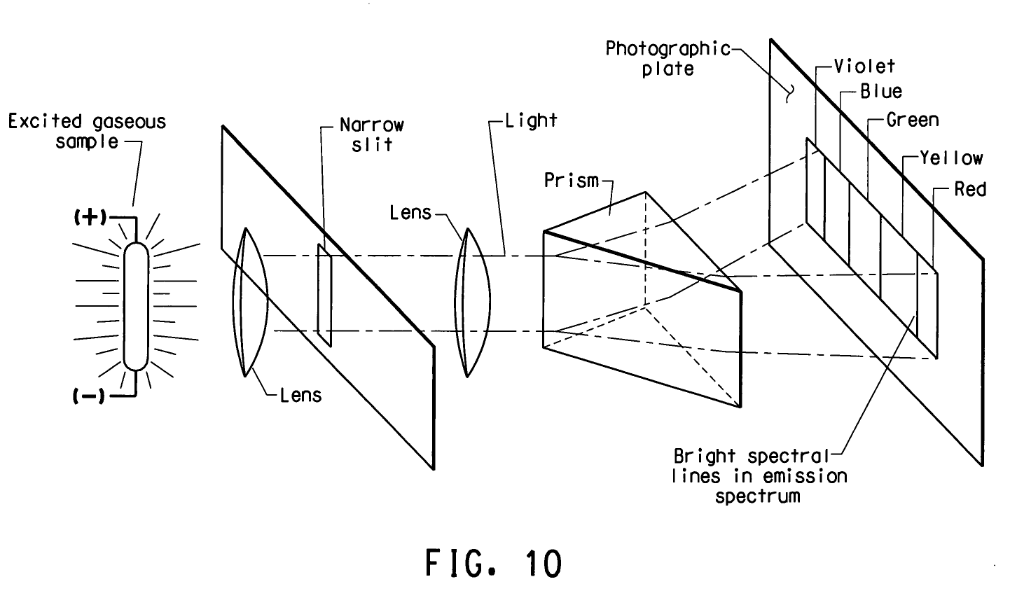

It was found that the alignment of DNA-CNT on the treated surface became very consistent across the entire deposition area. FIG. 6 shows three 3 μm×3 μm AFM images taken at three different spots ˜500 μm apart from each other. These demonstrate consistent alignment direction at the three spots.

### Example 9

This Example demonstrates that increasing deposition time resulted in increasing CNT density on a substrate. Carbon nanotubes were deposited onto a surface as described in Example 2. The samples were incubated for 1, 4 and 16 hours, respectively. The samples were rinsed and dried as described in Example 2. Aligned CNT were observed as described in Example 3. The number of CNTs deposited on the surface was counted in each sample. Within each observation field (about 3 μm×3 μm area), there were 6, 18 and 100 CNTs for 1, 4 and 16 hour samples, respectively.

What is claimed is:

1. A method of making an optical polarizer comprising the steps of:
a) providing a population of carbon nanotubes associated with a charged dispersant in solution;
b) depositing the solution of (a) on a transparent substrate whereby the population of carbon nanotubes are aligned;
c) washing the transparent substrate of (b) with a washing solvent;
d) drying the washed transparent substrate of (c) whereby the aligned carbon nanotubes are affixed to the transparent substrate;
e) optionally coating the aligned carbon nanotubes with a transparent coating;
f) optionally repeating steps (a)-(d) or steps (a)-(e) to obtain multiple substrates;
g) incorporating the substrate of (d) or (e) or the multiple substrates of (f) into an apparatus.

2. The method of claim 1, further comprising the steps of:
h) combining at least two substrates obtained from step (d), (e) or (f) to form a multiple polarizer;
i) optionally combining a reflective substrate together with the multiple polarizer of step (h);
j) incorporating the multiple polarizer of step (h) or (i) into an apparatus.

3. The method of claim 1 or 2 further comprising the step of:
k) increasing the density of the carbon nanotubes.

4. The method of claim 2, wherein the multiple polarizer polarizes a greater percentage of incident light with each combined substrate.

5. The method of claim 1, wherein the carbon nanotubes are single walled or multi-walled.

6. The method of claim 1 or claim 2, wherein the carbon nanotubes are substantially semiconducting or metallic.

7. The method of claim 1, wherein the carbon nanotubes are singly dispersed.

8. The method of claim 1, wherein the charged dispersant is a biopolymer selected from the group consisting of nucleic acids, polypeptides, and peptide nucleic acids.

9. The method of claim 1, wherein the substrate is selected from the group consisting of silicon, silicon dioxide, glass, polymers, crystals and combinations thereof.

10. The method of claim 9, wherein the substrate undergoes a pretreatment.

11. The method of claim 10, wherein the pretreatment makes the substrate more hydrophobic.

12. The method of claim 1, wherein the washing solvent is aqueous based.

13. The method of claim 1 or claim 2, wherein the alignment is performed in the presence of an external magnetic field.

14. The method of claim 1, wherein the transparent coating is selected from the group consisting of adhesives, conductive layers, antistatic coatings or film, abrasion resistant materials and optical coatings.

15. The method of claim 1 or 2, wherein the substrate is incorporated into an apparatus selected from the group consisting of cameras, camera phones, displays, microscopes, optical scanners, optical spectrometers, polarized lenses, three-dimensional displays, three-dimensional viewers, three-dimensional microscopes, telescopes, computer displays, television displays and personal digital assistants.

16. The method of claim 1 or 2, wherein the substrate or multiple polarizer is incorporated into a display.

17. An optical polarizer made according to the process of claim 1 or 2.

18. An apparatus comprising the optical polarizer of claim 17.

19. The apparatus of claim 18 selected from the group consisting of sunglasses, windshields, camera lenses, three-dimensional viewers, three-dimensional eyeglasses, spectroscopes, spectrophotometers, spectral analyzers, projection television displays and liquid crystal tunable filters.

20. A microscope comprising the optical polarizer of claim 17.

21. The microscope of claim 20 selected from the group consisting of optical microscopes, fluorescence microscopes, interference microscopes, compound microscopes, polarized-light microscope, birefringence imaging microscopes and scanning near-field optical microscopes.

22. A display comprising the optical polarizer of claim 17.

23. The display of claim 22 selected from the group consisting of a liquid crystal display, flat screen display and light emitting diode display.

24. The liquid crystal display of claim 23 comprising a liquid crystal cell and the optical polarizer manufactured according to the process of claim 1 or claim 2.
